(19) United States
(12) Patent Application Publication
(10) Pub. No.: US 2017/0200389 A1
(43) Pub. Date: Jul. 13, 2017

(54) POCKET THERAPIST

(71) Applicant: Omri Yigal, Hunter Army Airfield, GA (US)

(72) Inventor: Omri Yigal, Hunter Army Airfield, GA (US)

(21) Appl. No.: 14/992,786

(22) Filed: Jan. 11, 2016

(51) Int. Cl. G09B 19/00; G06F 19/00

(52) U.S. Cl. CPC G09B 19/00; G06F 19/322

(57) ABSTRACT

The Director of the National Institute of Mental Health and the Department of Veterans Affairs predict that 70 percent of soldiers who return from combat in Afghanistan and Iraq, many of whom suffer from depression and PTSD, will not seek treatment in either the military health care system or the V.A. hospitals. Suicide in the Army has reached epidemic proportions. A U.S. Court of Appeals has rule the health care at the V.A. hospitals to be unconstitutional. There have been more than 18 mass shooting on military bases since 2008. The combination of these forces on the civilian public mental health system will be catastrophic; and they have been described by the director of NIMH as “the gathering of a storm”. In concert with this dire prognosis it is entirely appropriate to factor in the extremely long delays at the V.A. hospitals and the epidemic problems they have with inadequate staff. One of the most obvious use and benefit of this invention for clinicians and technicians is the accessibility to intervention and care when and where ever the need arises. It can boost the effectiveness of conventional approaches to therapy or function as a stand-alone method of cognitive intervention and behavior modification. The mental health system in the U.S. is broken; and The Pocket Therapist is at least one of the tools, not unlike a valve, that eases pressure off a military and civilian mental health system that is on the verge of failure and collapse.

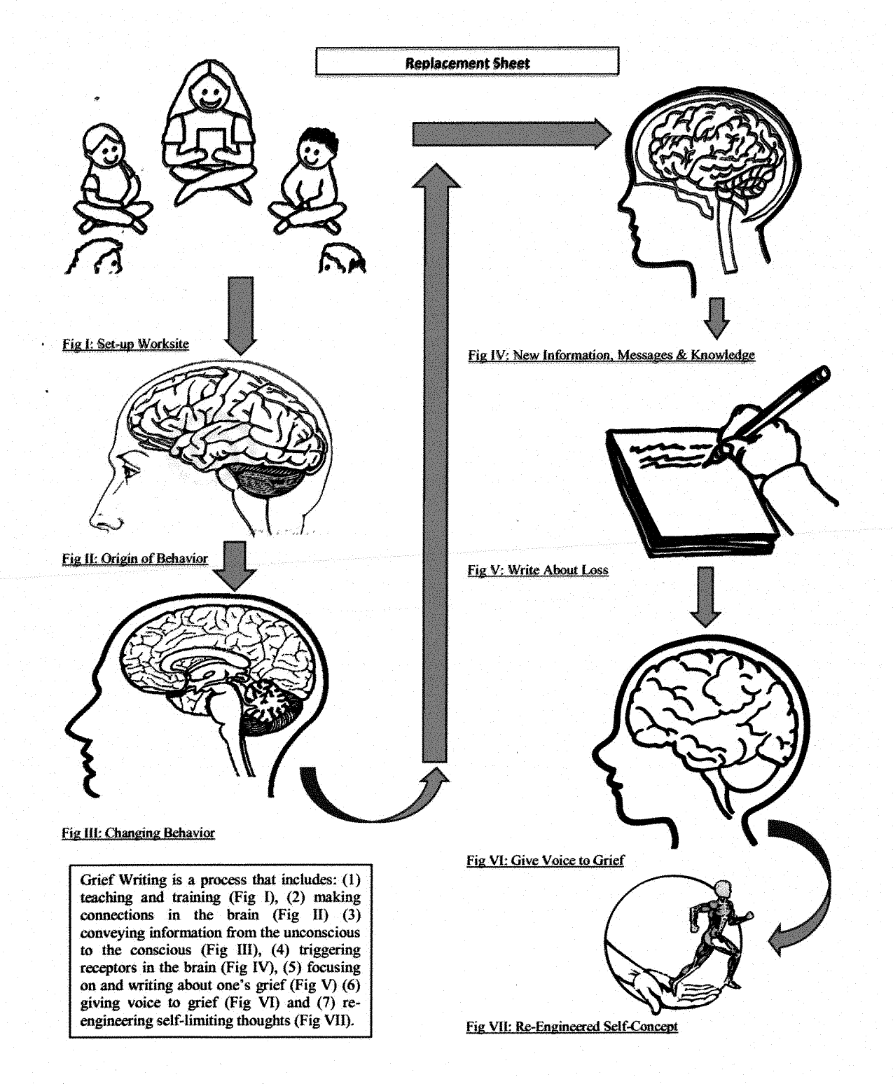

### TECHNICAL FIELD AND INDUSTRIAL APPLICABILITY OF THE INVENTION

This new and innovative invention relates to the field of psychological human development in general and more particularly how to use an innovative style of creative writing to achieve emotional wellness in the aftermath of grief, trauma, loss and triumph.

The invention uses a new cognitive behavior theory, behavior modification model and business process hereinafter known as Grief Writing to produce a novel result hereinafter known as The Pocket Therapist.

The poems and psalms written in Grief Writing are carriers of messages from the unconscious to the conscious. In the transportation of these messages, connections are made and community is formed. Writing about stressful experiences improves the ability to cope with them. Words, symbols and language redefine self-imposed limitations. Adaptive capacity and the ability to cope are expanded through individual and personal creative expression. Through creative writing, a cognitive shift is made from the old to the new; and the disfiguring scare of trauma is met with an equally formidable call to action to embrace the loss and celebrate life;

In individual or group settings, the inventor hosts emotional resilience and psychological reconnaissance training workshops and seminars on military bases; and subordinate to greater medical concerns, he instruct active-d lily troops and their dependents in the art of employing creative writing to give narrative and psalm to their grief and joy.

Through Grief Writing soldiers are able to make sense of their sorrows and joys . . . tragedies and triumphs. In short order and practice they can mitigate their emotional, psychological and spiritual pain associated with their feelings and fears. Soldiers and their dependents are taught how to frame their emotional experience into words and vehicles of positive expression. Grief Writing gives voice to the soldier's experience.

In the Grief Writing process, soldiers are taught emotional problem solving skills that allow them to tend to their wounds and notwithstanding the availability of conventional psychological intervention, heal themselves. Grief Writing and The Pocket Therapist fortify soldiers resolve when preparing for deployment or the battlefield. Armed, equipped and empowered with these skills, soldiers chose the time and place to do battle with their emotional conflicts or write about their conquests. This novel process is highly effective and beneficial in large part because although the grief writing process uses a standardized procedure in its application, every soldier receive customized psychological benefits irrespective of race, religion, creed, national origin, sexual orientation or social experience.

Over a not-too-distant time period, soldiers develop a substantial collection of sacred poems and psalms that journal his emotional experiences. It is at this juncture that the pocket therapist becomes a life-affirming, life-creating therapist in the pocket. It is no longer just a book.

In previous years, the U.S. Army has not given the attention to mental health as it might have warranted. Early approaches included low performance vehicles such as labeling those who sought care as “weak” and negatively stigmatizing cognitive health intervention. Soldiers perceived as “marginally productive” were given a medical discharge or early release. Most commanders simply adopted a hands-off need-help-seek-help approach and the results of which was nearly zero compliance. Today the Army is investing in grossly impersonal online and telephone crisis lines or worse, pre-disposed testing—the result of which could be used to kick soldiers out of the military.

Grief Writing and The Pocket Therapist are new and innovative approaches that improve upon past less effective methods that address cognitive intervention and psychological human development. The Pocket Therapist gives every soldier immediate access to healthy psychological intervention without delay; and this intervention can be the one soldiers chose in lieu of taking their own life.

As a new and innovative clinical design and procedure, this invention is different from everything else presently in the public domain. It ran be implemented with conventional methods of care or it can be a stand-alone cognitive intervention that leads to emotional wellness. The process of Grief Writing can go a long way to ending the long-standing problems of accessibility to care, excessive delays and professional training gaps in clinical education. A utility patent is required to protect the invention's application and utility from piracy and loss.

### BRIEF DESCRIPTION OF DRAWINGS

The technical drawings, in this utility patent application, illustrate the Grief Writing process that produces The Pocket Therapist. FIG. I depicts the one-on-one person-to-person training that facilitates learning. FIG. II denotes Grief Writing as a cognitive process. FIG. III tells readers that new messages and information will be introduced. FIG. IV conveys (to readers) that the transformation of new information will turn on-receptors in the brain and ignite brain cells. FIG. V reveals the fact that grief-specific writing must be done in Grief Writing; and FIG. VI and VII reveals Grief Writing re-engineers self-imposed limitations and it stands alone as the only psychological therapy that can be universally applied and results in a customized fit.

### BACKGROUND OF THE INVENTION

The United States Pentagon concedes the problem of suicide in the Army is epidemic, more soldiers are taking their own life today at any time in American history. Suicides are the most common form of death in the Army.

On the rare occasion when soldiers make an appointment in the mental health clinic on the military base, it is here that he will more likely than not be asked to focus and concentrate on some unconscious conflict or to probe his past life to discover a fault or justification for his emotional challenges. Perhaps the counselor or therapist tells the soldier what he should think or feel.

Since 2008 more than 18 mass shootings have occurred on military bases, including two at Ft. Hood, Tex. Not unlike suicide in the Army, with early intervention, these tragedies are preventable.

A U.S. Circuit Court of Appeals recently found the Department of Veterans Affairs mental health care system to be unconstitutional because it violated solders' constitutional rights to health care. V.A. hospitals are woefully understaffed with the adequate number of technicians and clinician staff needed to treat its population. By its own predictions, 70 percent of soldiers returning home for Iraq and Afghanistan theaters will not seek care at V.A. hospitals even though an increasing number of them suffer from PTSD and TBI injuries. Currently there is a present need for 28,000 mental health professionals in V.A. medical facilities; and this goal cannot be realistically attained for at least another 10 years! Over the course of the next ten years the present problems and delays at the V.A. hospitals will be exacerbated exponentially.

Rather than trying to change soldiers' beliefs or find justifications for conflict, The Pocket Therapist allows him to think for himself and express his feelings while developing emotional discipline, self-awareness and affirmation. Perhaps in the distant future when there are no stigmas attached to seeking mental health care, or when online crisis lines and telephone center are replaced with person-to-person intervention, or maybe when there is greater cognitive intervention and less psychiatric medication, then the clinician will be the best one to heal emotional obstacles; but for now the soldier may be the best clinician to solve his emotional challenges.

Soldiers are human beings; as such they need to express their loss; every heart needs to express its pain and how these debilitating events have shaped who they are. Grief Writing and The Pocket Therapist are novel approaches for behavior modification and social change; they are tools that allow survivors to peel away at the debilitating effects of loss and trauma to the sense of self. They provide soldiers with the reconnaissance and resilience skills needed to think and choose prospectively in the face of overwhelming emotional challenges. They are new, innovative and industrializable alternative to cognitive dissonance and to a large extent, social violence.

What is claimed is:

1. Medical research has shown creative writing improves sleep, boost immune cell activity and speed up post-surgery healing; building upon this research, the inventor claims, as his own, the following inventions:
1. The words Grief Writing are my inventions; they are a subset of creative writing and describe a process of writing poems, psalms and sacred writings to express one's grief and loss;
2. The name The Pocket Therapist is my creation and it is a collection of writings about one's own personal loss;
3. The functionality of Grief Writing and The Pocket Therapist are my invention and are workshop designs that provide emotional reconnaissance and psychological resilience aptitude, skills and training;
4. As referenced in claim 3, the clinical approach to training active duty soldiers is my original idea and is intended to reverse the epidemic trend of suicide in the military;
5. As referenced in claim 3, the implementation of the behavior modification model is my original idea and it is one that can be universally applied and produce customized results for every soldier;

6. As referenced in claim 3, the utility of Grief Writing and The Pocket Therapist are my new and innovative inventions that, in concert with the other, modify human behavior;
The basis upon which the inventor seek a utility patent for his invention is to protect it from exploits of others be they profiteers or altruistic in nature. He seeks the privilege of sharing his knowledge, experiences and invention with the world without infringement, piracy, theft and use without permission or loss of control.
